(19) United States
(12) Patent Application Publication
(10) Pub. No.: US 2009/0063576 A1
(43) Pub. Date: Mar. 5, 2009

(54) System and method for information management

(75) Inventor: Nabil Mesbah, Paris (FR)

Correspondence Address: Davidson, Davidson & Kappel, LLC, 485 7th Avenue, 14th Floor, New York, NY, 10018, US

(73) Assignee: ALSTOM TRANSPORT SA, Levallois-Perret (FR)

(21) Appl. No.: 12/221,773

(22) Filed: Aug. 6, 2008

(30) Foreign Application Priority Data
Aug. 7, 2007 (FR) 07 56975

(51) Int. Cl. G06F 17/30

(52) U.S. Cl. 707/201; 707/E17.005

(57) ABSTRACT

The system comprises a first data store which comprises a first physical storage medium, in which occurrences of information are recorded, and a second data store which comprises a second physical storage medium, in which occurrences of information are recorded.

The system further comprises, for each item of information from a set of information, of which a first occurrence is recorded in the first physical storage medium and a second occurrence is recorded in the second physical storage medium, an item of software for monitoring the first occurrence of the information, and an item of software for modification of the second occurrence of the information.

The present invention relates to a system for management of information between data stores.

### BACKGROUND OF THE INVENTION

A data store is a data-processing means for organised storage of a set of data. The storage is controlled by a single item of software and is then generally referred to as a database, or by a plurality of items of software, each one controlling a portion of the data from the set.

The invention is used quite specifically in the case of two data stores which are heterogeneous, that is to say, in which the organisation of the data is different.

In the prior art, it is known to have a first data store for storing information and a second data store in which a duplicate copy of the information of the first data store is stored.

This is the case, for example, for the production of manuals which are constituted by a document for structured presentation of information describing a machine.

An archivist who wishes to produce such a manual requires a data store which groups items of information relating to at least one machine, for example, a train.

The data store, referred to as a reference store, is installed on a server which can be accessed by a network in order for authorised persons to be able to develop it remotely. In this manner, data can be added, deleted or modified.

Generally, these authorised persons do not directly modify the reference store, but instead a source store which gathers the specific items of information used by a department of the company; source store of the R&D department, source store of the maintenance department, etcetera. In the same manner, the source store may be external to the company and constitute the database of a sub-contractor.

In order to ensure that the reference store is up to date, it is known to copy the complete contents of the source stores to the reference store at regular intervals.

One problem with this prior art is the fact that the copying operation is long and requires significant data-processing resources since all of the data is copied. Furthermore, between the periods of updating, the changes which are made to a source store are not reflected in the reference store of the archivist.

### SUMMARY OF THE INVENTION

The object of the invention is to overcome this problem by providing a system for updating in real time between two data stores:
a first data store comprising:
   a first physical storage medium, in which occurrences of information are recorded,
a second data store comprising:
   a second physical storage medium in which occurrences of information are recorded,
the information management system being characterised in that it comprises, for each item of information from a set of information, of which a first occurrence is recorded in the first physical storage medium and a second occurrence is recorded in the second physical storage medium:
   an item of software for monitoring the first occurrence of the information,
   an item of software for modification of the second occurrence of the information,
each item of monitoring software being associated with a single first occurrence of information, each item of modification software being associated with a single second occurrence of information,
the monitoring software being configured, in the event of modification of the first occurrence, to send a modification message to the modification software, this modification message comprising data which represent the modification of the first occurrence of the information,
the modification software being configured, following receipt of the modification message from the monitoring software, to modify the second occurrence of the information from the data which represent the modification of the first occurrence, the monitoring software and the modification software each being capable of being implemented independently of the implementation of the others.

According to specific embodiments, the system comprises one or more of the following features, taken in isolation or according to any technically possible combination:
the monitoring software is configured, following modification of the first occurrence, to read the first occurrence of the information, the data which represent the modification of the first occurrence of the information comprising the first occurrence read,
the modification message sent to the modification software comprises only the modifications made to the first occurrence,
it comprises:
   a data-processing document comprising at least a third occurrence of an item of information from the set of information, a first occurrence of which is recorded in the first physical storage medium and a second occurrence of which is recorded in the second physical storage medium,
   device for displaying the document, which device is configured to process the data-processing document in order to generate display instructions which are, for example, intended for a screen or a printer, and
   for each third occurrence, an item of software for updating the third occurrence of the information, which is configured to:
   read the second occurrence of the information,
   copy into the data-processing document the third occurrence of the information, via the second occurrence which has been read,
the display device being configured to call up the items of software for updating all the third occurrences of information from the data-processing document so that these items of updating software carry out the preceding steps.

The invention also relates to a method for management of items of information from an information system as described above, characterised in that it involves:
if the first occurrence is modified, the monitoring software sending a modification message to the modification software, this modification message comprising data which represent the modification of the first occurrence of the information,
following receipt of the modification message by the modification software representing the modification of the first occurrence of the information, the modification by the modification software of the second occurrence of the information from the data representing the modification of the first occurrence of the information.

The invention will be better understood from the following description, given purely by way of example and with reference to the appended drawings.

### BRIEF DESCRIPTION OF THE DRAWINGS

FIG. 1 is a schematic illustration of an information management system according to the invention; and

FIG. 2 is a block diagram illustrating the method steps implemented by the system of FIG. 1.

### DETAILED DESCRIPTION OF THE PREFERRED EMBODIMENT

The information management system of the invention controls items of information which are duplicated in a plurality of data-processing devices. In the following description, reference will therefore be made to one item of information in order to indicate each duplication of this information.

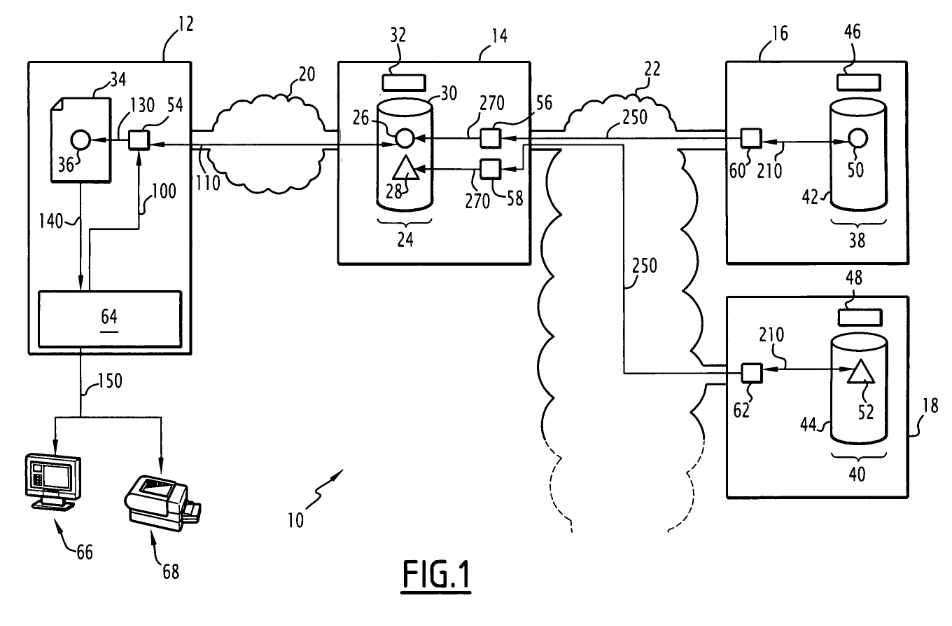

With reference to FIG. 1, the information management system, generally designated 10, comprises at least one computer 12, a first server, referred to as a reference server 14, and one or more other servers which are referred to as source servers 16, 18.

The reference server 14 is connected, on the one hand, to the computer 12 via a first data exchange network 20 and, on the other hand, to the source servers 16, 18 via a second data exchange network 22 which may be the same as the first network 20. These networks 20, 22 are, for example, the Internet, or a local network of the LAN type, and preferably allow connections at distances of between 100 metres and several kilometres.

The reference server 14 comprises a data store, referred to as a reference store 24, which groups in an organised manner occurrences 26, 28 of information A, B. The reference store 24 comprises, on the one hand, a physical storage medium 30 in which the occurrences 26, 28 of the information A, B are recorded and, on the other hand, an item of software 32 for managing the physical medium 30, this management software 32 being suitable for receiving requests for consultation or modification of the occurrences of information recorded in the physical storage medium 30. The information A, B is intended to be used by the computer(s) 12 and originates from the source servers 16, 18.

A data-processing document 34 is recorded in the memory of the computer 12. This document 34 is a technical manual for presenting a plurality of items of information in a structured form. This information relates, for example, to components or maintenance procedures for machines and is, for example, text or an image. The items of information are recorded in the document 34 in the form of occurrences of information, referred to as local occurrences.

For reasons of clarity, document 34 of FIG. 1 comprises only a single local occurrence 36 of the information A (the information B is not used in document 40). Of course, in practice, the document 34 generally groups together a plurality of occurrences of information.

Each source server 16, 18 comprises a respective data store, referred to as a source store 38, 40 which groups occurrences of information in an organised manner. These occurrences are referred to as source occurrences 50, 52.

Each source store 38, 40 comprises, on the one hand, a physical storage medium 42, 44 in which occurrences of information are recorded and, on the other hand, an item of software 46, 48 for managing the physical storage medium 42, 44, this management software 46, 48 being capable of receiving requests for consultation or modification of the occurrences of information recorded in the physical storage medium, the requests being edited in a second request language.

In the example illustrated, the first source store 38 comprises a source occurrence of the information A, whilst the second source store 40 comprises a source occurrence 52 of the information B.

Generally, the reference server 14 and the computer(s) 12 are installed and managed by the same company, for example, a machine manufacturing company. The source servers 16, 18 are each installed either at the premises of a sub-contractor, or within the company, for example, in a remote site. The technical staff therefore have access to the source stores 38, 40 in order to be able to modify the occurrences 50, 52 of the information A, B which they contain.

Each of the data stores 38, 40 is capable of processing requests which are sent to it in order, for example, to modify or simply consult the data which it contains. The editing language of these requests depends on the type of data store. In this manner, requests will be edited in the language Oracle when the data store is an Oracle database, whilst requests will be edited in the language Access when the data store is an Access database.

In order to reflect the modifications of the source occurrences 38, 40 of the information A, B in the other occurrences of the information A, B, the management system 10 comprises a plurality of data-processing agents.

A data-processing agent is a software entity (programme, process, routine, etcetera) implemented by data-processing hardware in order to carry out specific tasks. Each data-processing agent is independent of the other data-processing agents. This means that the operation of an agent is not connected to the operation of the other agents. In this manner, an agent functions even if the other agents are stopped, for example, following a malfunction of part of the system 10.

Furthermore, the data-processing agents are independent of the management software of the data stores, that is to say, they are capable of being implemented independently of the implementation of the management software. In this manner, the data-processing agents attach themselves to functional data stores which already exist. Owing to this structure, it is simple to add or remove agents, since it is not necessary to modify the data store itself.

The agents are divided into three categories: the agents which are referred to as local agents and carried out by the computer 12, the agents which are referred to as reference agents and are carried out by the reference server 14, and the agents which are referred to as source agents and are carried out by the source servers 16, 18.

Each local occurrence 16 of the data-processing document 34 is associated with a local agent. In FIG. 1, a single local agent 54 is illustrated, and is associated with the local occurrence 36 of the information A.

The reference server 14 comprises, for each reference occurrence 26, 28, an associated data-processing agent, referred to as a reference agent 56, 58. Each reference agent 56, 58 is responsible for reflecting the modifications made to the source occurrences 50, 52 in the reference store 24. Each reference agent is associated with a single respective source agent 60, 62.

Each source agent 60, 62 is associated with a single source occurrence of information 50, 52 and is intended to monitor the associated source occurrence 50, 52 in order to advise the associated reference agent 50, 52 of the occurrence of a modification.

The computer 12 further comprises a device 64 for displaying the data-processing document 34. This device 64 is, for example, configured to send display instructions to a computer screen 66, or printing instructions to a printer 68. The display device 64 is further configured to request the local agents 54 to verify the updating of the local occurrences 36 of the data-processing document 34, and, if necessary, to update these local occurrences 34 from the reference server 14 before the display or printing instructions are sent.

The device 64 comprises, for example, computer hardware and computer software for achieving the functions previously detailed.

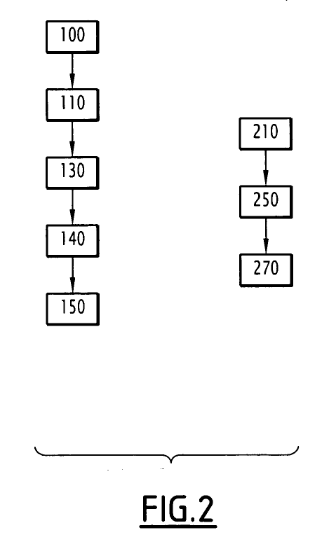

The operation of the information management system 10 will now be described, with reference to FIGS. 1 and 2.

When the data of the system 10 is up to date, the associated occurrences of the same item of information, that is to say, the source occurrences, reference occurrences and optionally local occurrences are identical.

However, when a source occurrence of an item of information is modified, it is necessary to update the other occurrences (reference and local) as a result.

In this manner, the information management system 10 implements a first method for updating between the computer 12 and the reference server 14.

The first method begins when a user activates the display device 64 in order to display the document 34.

There follows a first step 100 during which the display device 64 calls up each local agent 54.

In response to the request, each agent 54 reads (step 110) the reference occurrence 26 in the reference store 14. This reading is carried out directly on the data medium 30, without passing via the management software 30. The local agent 54 copies (step 130) this occurrence which has been read in place of the associated local occurrence 36.

When all the information occurrences 36 from the document 34 have been copied by the respective agents 54, the document 34 is processed (step 140) using the display device 64 so that the display instructions of this document 34 are sent (step 150) to the screen 66 and/or to the printer 68.

In this manner, the document displayed by the user always takes into account the latest items of information, as they are set out in the reference store 14.

Furthermore, the information management system 10 implements a second updating method between the reference store 14 and each of the source stores 38, 40. This second method is implemented in a continuous manner, independently of the implementation of the first updating method. The following steps relate to an associated source agent/reference agent pairing. Of course, the steps are also implemented by the other pairs (for example, the pair 58/62), but in an independent manner.

Following the modification of the source occurrence, the source agent 52 reads (step 210) the source occurrence of the data store 38, this reading being carried out directly on the data medium 42, without passing via the management software 46. Then, it sends (step 250) a modification message which comprises the occurrence 50 which has been read. This occurrence 50 which has been read thus constitutes modification data which are intended to update the reference occurrence 26.

In the alternative, the modification message comprises only the modifications which have been made to the occurrence 50 which has been read.

Following receipt of the modification message from the source agent 60, the reference agent modifies (step 270) the reference occurrence 26 from the data which represent the modification of the first occurrence of the information 50 of the step 250.

If these data are the source occurrence 50 which has been read, the step 270 involves overwriting the reference occurrence with the source occurrence which has been read.

In this manner, the reference store 24 is updated almost in real time with respect to the modifications made to the source stores 38, 40.

1. An information management system, comprising:
a first data store including a first physical storage medium, in which occurrences of information are recorded,
a second data store including a second physical storage medium in which occurrences of information are recorded,
the information management system including for each item of information from a set of information, of which a first occurrence is recorded in the first physical storage medium and a second occurrence is recorded in the second physical storage medium:
an item of software for monitoring the first occurrence of the information,
an item of software for modification of the second occurrence of the information,
the monitoring software being configured, in the event of modification of the first occurrence, to send a modification message to the modification software, the modification message comprising data which represent the modification of the first occurrence of the information,
each item of monitoring software being associated with a single first occurrence of information, each item of modification software being associated with a single second occurrence of information,
the modification software being configured, following receipt of the modification message from the monitoring software, to modify the second occurrence of the information from the data which represent the modification of the first occurrence, the monitoring software and the modification software each being capable of being implemented independently of the implementation of the others.

2. The information management system according to claim 1, wherein the monitoring software is configured, following modification of the first occurrence, to read the first occurrence of the information, the data which represent the modification of the first occurrence of the information comprising the first occurrence read.

3. The information management system according to claim 1, wherein the modification message to the modification software comprises only the modifications made to the first occurrence.

4. The information management system according to claim 1, comprising:
a data-processing document including at least a third occurrence of an item of information from the set of information, a first occurrence of which is recorded in the first physical storage medium and a second occurrence of which is recorded in the second physical storage medium,
device for displaying the document, which device is configured to process the data-processing document in order to generate display instructions which are, for example, intended for a screen or a printer, and
for each third occurrence, an item of software for updating the third occurrence of the information, which is configured to:
read the second occurrence of the information,
copy into the data-processing document the third occurrence of the information, via the second occurrence which has been read,
the display device being configured to call up the software for updating all the third occurrences of information from the data-processing document so that these items of updating software carry out the preceding steps.

5. The information management system according to claim 2, comprising:
a data-processing document including at least a third occurrence of an item of information from the set of information, a first occurrence of which is recorded in the first physical storage medium and a second occurrence of which is recorded in the second physical storage medium,
device for displaying the document, which device is configured to process the data-processing document in order to generate display instructions which are, for example, intended for a screen or a printer, and
for each third occurrence, an item of software for updating the third occurrence of the information, which is configured to:
read the second occurrence of the information,
copy into the data-processing document the third occurrence of the information, via the second occurrence which has been read,
the display device being configured to call up the software for updating all the third occurrences of information from the data-processing document so that these items of updating software carry out the preceding steps.

6. The information management system according to claim 3, comprising:
a data-processing document including at least a third occurrence of an item of information from the set of information, a first occurrence of which is recorded in the first physical storage medium and a second occurrence of which is recorded in the second physical storage medium,
device for displaying the document, which device is configured to process the data-processing document in order to generate display instructions which are, for example, intended for a screen or a printer, and
for each third occurrence, an item of software for updating the third occurrence of the information, which is configured to:
read the second occurrence of the information,
copy into the data-processing document the third occurrence of the information, via the second occurrence which has been read,
the display device being configured to call up the software for updating all the third occurrences of information from the data-processing document so that these items of updating software carry out the preceding steps.

7. A method for management of items of information from an information system according to claim 1, comprising the steps of:
if the first occurrence is modified, the monitoring software sending a modification message to the modification software, this modification message comprising data which represent the modification of the first occurrence of the information,
following receipt of the modification message by the modification software representing the modification of the first occurrence of the information, the modification by the modification software of the second occurrence of the information from the data representing the modification of the first occurrence of the information.

8. A method for management of items of information from an information system according to claim 2, comprising the steps of:
if the first occurrence is modified, the monitoring software sending a modification message to the modification software, this modification message comprising data which represent the modification of the first occurrence of the information,
following receipt of the modification message by the modification software representing the modification of the first occurrence of the information, the modification by the modification software of the second occurrence of the information from the data representing the modification of the first occurrence of the information.

9. A method for management of items of information from an information system according to claim 3, comprising the steps of:
if the first occurrence is modified, the monitoring software sending a modification message to the modification software, this modification message comprising data which represent the modification of the first occurrence of the information,
following receipt of the modification message by the modification software representing the modification of the first occurrence of the information, the modification by the modification software of the second occurrence of the information from the data representing the modification of the first occurrence of the information.

10. A method for management of items of information from an information system according to claim 4, comprising the steps of:
if the first occurrence is modified, the monitoring software sending a modification message to the modification software, this modification message comprising data which represent the modification of the first occurrence of the information,
following receipt of the modification message by the modification software representing the modification of the first occurrence of the information, the modification by the modification software of the second occurrence of the information from the data representing the modification of the first occurrence of the information.

11. A method for management of items of information from an information system according to claim 5, comprising the steps of:
if the first occurrence is modified, the monitoring software sending a modification message to the modification software, this modification message comprising data which represent the modification of the first occurrence of the information,
following receipt of the modification message by the modification software representing the modification of the first occurrence of the information, the modification by the modification software of the second occurrence of the information from the data representing the modification of the first occurrence of the information.

12. A method for management of items of information from an information system according to claim 6, comprising the steps of:
if the first occurrence is modified, the monitoring software sending a modification message to the modification software, this modification message comprising data which represent the modification of the first occurrence of the information,
following receipt of the modification message by the modification software representing the modification of the first occurrence of the information, the modification by the modification software of the second occurrence of the information from the data representing the modification of the first occurrence of the information.
